(19) United States
(12) Patent Application Publication
(10) Pub. No.: US 2003/0130390 A1
(43) Pub. Date: Jul. 10, 2003

(54) Transparent thermoplastischic composition

(76) Inventors: Rudiger Gorny, Krefeld (DE); Siegfried Anders, Koln (DE); Wolfgang Nising, Sankt Augustin (DE); Wilfried Haese, Odenthal (DE)

Correspondence Address: BAYER POLYMERS LLC, 100 BAYER ROAD, PITTSBURGH, PA, 15205, US

(21) Appl. No.: 10/296,340

(22) PCT Filed: May 16, 2001
(86) PCT No.: PCT/EP01/05562

(30) Foreign Application Priority Data
May 29, 2000 (DE) 100 26 628.2

(51) Int. Cl. C08K 5/10; C08K 5/13

(52) U.S. Cl. 524/307; 524/323

(57) ABSTRACT

A transparent thermoplastic molding composition suitable for the preparation of UV-stable products having high light transmission and low haze values is disclosed. The composition contains a transparent thermoplastic polymer and one or more compounds conforming to formula (I)

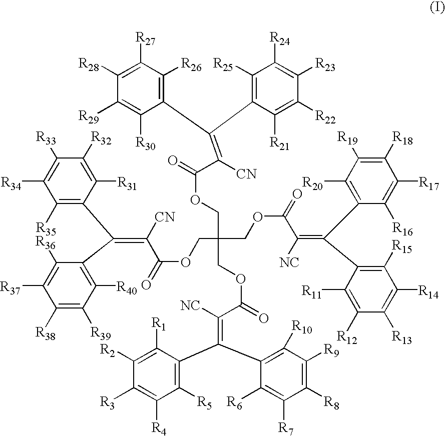

wherein R₁ to R₄₀ independently denote a member selected from the group consisting of H, alkyl, halogen and —CN.

The present invention relates to a composition containing a transparent thermoplastic polymer and compounds according to formula (I)

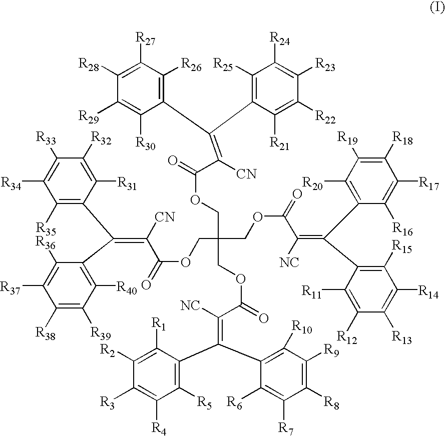

wherein

R₁ to R₄₀ are the same or different and are selected from the group consisting of H, alkyl, halogen and —CN,

and products made therefrom.

Polycarbonate sheets are known, e.g. from EP-A 0 110 221, and are provided for a large number of applications. Production takes place e.g. by extrusion of compositions containing polycarbonate and optionally co-extrusion with compositions containing polycarbonate that can contain an elevated proportion of UV absorbers.

Products of compositions containing polycarbonate, such as e.g. spectacle lenses and plastic headlight lenses, are preferably made by injection moulding. Automobile glazing can be made by either injection moulding or extrusion, as desired.

Important factors in the selection of transparent polycarbonate sheets are high light transmission and low haze. So that the UV portion of sunlight does not lead to severe yellowing of the sheets, the polycarbonate normally incorporates at least one UV stabiliser. In the case of transparent glazing, increased haze of the sheet leads to poorer visibility of objects behind it. The haze effect is optically more noticeable the thicker the sheet. Low haze is particularly important, for example, in automobile glazing.

DE-A 1 670 951 teaches that UV absorbers based, e.g., on substituted benzotriazoles are used for stabilising polycarbonate against yellowing under the action of UV light. For long-term protection from yellowing by UV light, EP-A 0 320 632 teaches that the polycarbonate sheets should incorporate a co-extrusion layer containing low-volatility UV absorbers, especially dimeric benzotriazoles, such as e.g. Tinuvin® 360 (bis[2-hydroxy-5-tert-octyl-3-(benzotriazol-2-yl)phenyl]methane), a product of Ciba Spezialitätenchemie, Basel, Switzerland, in a sufficiently high concentration.

WO 96/15102 describes special UV absorbers, including those according to formula (I), which act as a light stabiliser or a stabiliser for organic materials, such as e.g. plastics.

WO 96/15102 teaches that a content of 0.01 to 10 wt. % of the UV absorbers described there bring about UV protection in organic materials. However, nothing is said about the quality of the UV protection in polycarbonate. Also, no teaching is disclosed as to how low-haze compositions can be obtained.

The present invention is based on the object of providing compositions that are stable towards UV radiation and exhibit high light transmission and low haze. Furthermore, products made from these compositions are to be provided.

The object according to the invention is achieved by compositions containing

a) a transparent thermoplastic polymer and

b) one or more different compounds according to formula (I)

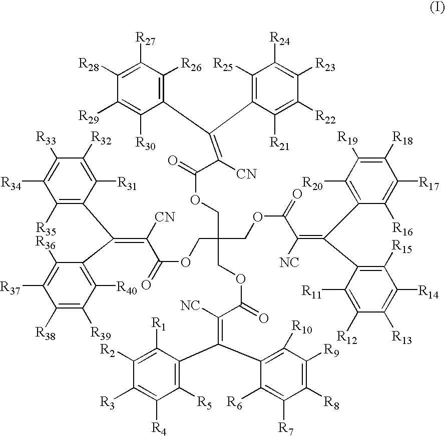

wherein

R₁ to R₄₀ are the same or different and are selected from the group consisting of H, alkyl, halogen and —CN,

and products made therefrom.

The composition according to the invention preferably contains 0.08 to 0.6 wt. %, particularly preferably 0.1 to 0.3 wt. %, of the compounds according to formula (I). R₁ to R₄₀ preferably equal H (hydrogen).

The transparent thermoplastic polymer according to the invention is preferably selected from the group consisting of polycarbonate, polymethyl methacrylate, polyethyl methacrylate, polystyrene, polysulfone, styrene-acrylonitrile copolymer, polyester, polyethylene terephthalate, polybutylene terephthalate, copolyesters of polyethylene terephthalate with cyclohexanedimethanol, copolyesters of polybutylene terephthalate with cyclohexanedimethanol, polyether sulfone, polyethylene, polypropylene and mixtures of the above polymers, those polymers and mixtures that can be processed into highly transparent, crystal clear products being preferred.

The transparent thermoplastic polymer polycarbonate is especially preferred.

Polycarbonates preferred according to the invention are polycarbonates based on bisphenol A, especially bisphenol A homopolycarbonate and copolycarbonates based on bisphenol A and 1,1-bis(4-hydroxyphenyl)-3,3,5-trimethylcyclohexane.

Particularly suitable transparent thermoplastic polymers are also copolycarbonates based on bisphenols, poly- or copolyacrylates and poly- or copolymethacrylates, such as e.g. poly- or copolymethyl methacrylate, copolymers with styrene, such as e.g. transparent polystyrene-acrylonitrile (SAN), and also transparent cycloolefins, poly- or copolycondensates of terephthalic acid, such as e.g. poly- or copolyethylene terephthalate (PET or CoPET or PETG).

Examples of polyesters and copolyesters are described in EP-A 0 678 376, EP-A 0 595 413 and U.S. Pat. No. 6,096,854.

Further, the compositions according to the invention preferably also contain 0.01 to 1 wt. %, particularly preferably 0.04 to 0.7 wt. %, pentaerythritol tetrastearate or glycerol monostearate or fatty acid esters of Guerbet alcohols or mixtures thereof.

The object according to the invention is also achieved by products containing the composition according to the above paragraphs.

Products selected from the group consisting of sheets, solid sheets, multi wall sheets, corrugated sheets, glazing panels, greenhouses, conservatories, bus shelters, advertising panels, signs, safety screens, automobile glazing, windows, roofing, plastic headlight lenses and spectacle lenses are preferred.

Products that are multi-layer, and in which at least one layer contains a sufficiently high content of a UV absorber that the layers below it are protected from the harmful effects of UV light, are also preferred. A preferred embodiment of the present invention is provided by the fact that the UV absorber contained in at least one layer is a compound according to formula (I). Another preferred embodiment of the present invention is provided by the fact that the UV absorber contained in at least one layer is another compound.

Another preferred embodiment according to the invention is provided by the fact that the transparent thermoplastic polymer is a polymer blend consisting of at least 20 wt. % polycarbonate, the polymer blend also containing polyesters or polymethacrylates or both as blend partners in addition to polycarbonate.

The compound according to formula (I) with R₁ to R₄₀ equal to H is commercially available as Uvinul® 3030 from BASF AG, Ludwigshafen, Germany.

The production of the compound according to formula (I) with R₁ to R₄₀ equal to H is described in WO 96/15102. The compounds according to formula a) in which R₁ to R₄₀ have a different meaning can be produced by corresponding processes.

Since the compounds according to formula (I) are of low volatility, it is possible to use them as described in EP-A 0 320 632 in compositions containing transparent thermoplastic polymers as UV protection for co-extruded sheets (use in co-extrusion moulding compositions).

Surprisingly, it has been shown that, when the compounds according to formula (I) are used in concentrations of 0.08 to 0.6 wt. %, preferably 0.1 to 0.3 wt. %, the haze and light transmission are better than with the conventional benzotriazole UV absorbers.

The polycarbonates according to the invention are homopolycarbonates, copolycarbonates and thermoplastic polyester carbonates. They preferably have average molecular weights \overline{M}_{w} of 18,000 to 40,000 g/mol, preferably of 20,000 to 36,000 g/mol and especially of 22,000 to 35,000 g/mol, determined by measuring the relative solution viscosity in dichloromethane or in mixtures of equal quantities by weight of phenol/o-dichlorobenzene calibrated by light scattering.

For the production of polycarbonates for the compositions according to the invention, reference is made, for example, to Schnell, “Chemistry and Physics of Polycarbonates”, Polymer Reviews, vol. 9, Interscience Publishers, New York, London, Sydney 1964, to D. C. PREVORSEK, B. T. DEBONA and Y. KESTEN, Corporate Research Center, Allied Chemical Corporation, Moristown, N.J. 07960, “Synthesis of Poly(ester)carbonate Copolymers” in Journal of Polymer Science, Polymer Chemistry Edition, vol. 19, 75-90 (1980), to D. Freitag, U. Grigo, P. R. Müller, N. Nouvertne, BAYER AG, “Polycarbonates” in Encyclopedia of Polymer Science and Engineering, vol. 11, second edition, 1988, pages 648-718 and finally to Drs. U. Grigo, K. Kircher and P. R Müller “Polycarbonate” in Becker/Braun, Kunststoff-Handbuch, vol. 3/1, Polycarbonate, Polyacetale, Polyester, Celluloseester, Carl Hanser Verlag Munich, Vienna, 1992, pages 117-299.

The production of polycarbonate preferably takes place by the interfacial polycondensation process or the melt transesterification process and is described using the interfacial polycondensation process as an example.

Compounds preferably to be used as starting compounds are bisphenols of the general formula HO—Z—OH, wherein Z is a divalent organic radical with 6 to 30 carbon atoms, which contains one or more aromatic groups. Examples of such compounds are bisphenols belonging to the group of the dihydroxydiphenyls, bis(hydroxyphenyl)-alkanes, indane bisphenols, bis(hydroxyphenyl) ethers, bis(hydroxyphenyl) sulfones, bis(hydroxyphenyl) ketones and α,α′-bis(hydroxyphenyl)diisopropylbenzenes.

Preferred bisphenols belonging to the above-mentioned groups of compounds are bisphenol A, tetraalkylbisphenol A, 4,4-(meta-phenylenediisopropyl) diphenol (bisphenol M), 4,4-(para-phenylenediisopropyl) diphenol, 1,1-bis(4-hydroxyphenyl)-3,3,5-trimethylcyclohexane (BP-TMC), 2,2-bis(4-hydroxyphenyl)-2-phenylethane, 1,1-bis(4-hydroxyphenyl)cyclohexane (bisphenol Z) and optionally mixtures thereof.

The bisphenol compounds to be used according to the invention are preferably reacted with carbonic acid compounds, especially phosgene or, in the melt transesterification process, preferably with diphenyl carbonate or dimethyl carbonate. Polyester carbonates are obtained by reacting the bisphenols already mentioned, at least one aromatic dicarboxylic acid and optionally carbonic acid equivalents. Suitable aromatic dicarboxylic acids for this purpose are, for example, phthalic acid, terephthalic acid, isophthalic acid, 3,3′- or 4,4′-diphenyldicarboxylic acid and benzophenonedicarboxylic acids. A part, up to 80 mole %, preferably 20 to 50 mole %, of the carbonate groups in the polycarbonates can be replaced by aromatic dicarboxylate groups and are also referred to as polycarbonate according to the invention.

Inert organic solvents used in the interfacial polycondensation process are, for example, dichloromethane, the various dichloroethanes and chloropropane compounds, tetra-chloromethane, trichloromethane, chlorobenzene and chlorotoluene; chlorobenzene or dichloromethane or mixtures of dichloromethane and chlorobenzene are preferably used.

The interfacial polycondensation reaction can be accelerated by catalysts, such as tertiary amines, especially N-alkylpiperidines or onium salts. Tributylamine, triethylamine and N-ethylpiperidine are preferably used. In the case of the melt transesterification process, e.g. the catalysts mentioned in DE-A 4 238 123 are used.

The polycarbonates can be branched in a deliberate and controlled manner by using small quantities of branching agents. Some suitable branching agents are: phloroglucinol, 4,6-dimethyl-2,4,6-tri(4-hydroxyphenyl)-2-heptene; 4,6-dimethyl-2,4,6-tri(4-hydroxyphenyl)heptane; 1,3,5-tri(4-hydroxyphenyl)benzene; 1,1,1-tri(4-hydroxyphenyl)ethane; tri(4-hydroxyphenyl)phenylmethane; 2,2-bis[4,4-bis(4-hydroxyphenyl)cyclohexyl]propane; 2,4-bis(4-hydroxyphenylisopropyl)phenol; 2,6-bis(2-hydroxy-5′-methylbenzyl)-4-methylphenol; 2-(4-hydroxyphenyl)-2-(2,4-dihydroxyphenyl)propane; hexa(4-(4-hydroxyphenylisopropyl)phenyl) orthoterephthalate; tetra(4-hydroxyphenyl)methane; tetra(4-(4-hydroxyphenylisopropyl)phenoxy)methane; α,α′,α″-tris(4-hydroxyphenyl)-1,3,5-triisopropylbenzene; 2,4-dihydroxybenzoic acid; trimesic acid; cyanuric chloride; 3,3-bis(3-methyl-4-hydroxyphenyl )-2-oxo-2,3-dihydroindole; 1,4-bis-(4′,4″-dihydroxytriphenyl)methyl)benzene and especially: 1,1,1-tri(4-hydroxyphenyl)ethane and bis(3-methyl-4-hydroxyphenyl)-2-oxo-2,3-dihydroindole.

The 0.05 to 2 mole %, based on bisphenols used, of branching agents or mixtures of branching agents that can optionally be incorporated can be fed in together with the bisphenols or added at a later stage of the synthesis.

Chain terminators can be used. Phenols such as phenol, allkylphenols such as cresol and 4-tert-butylphenol, chlorophenol, bromophenol, cumylphenol or mixtures thereof are preferably used as chain terminators in quantities of preferably 1-20 mole %, particularly preferably 2-10 mole % per mole of bisphenol. Phenol, 4-tert-butylphenol and cumylphenol are preferred.

Chain terminators and branching agents can be added separately or together with the bisphenol during the synthesis.

The production of the polycarbonates for the compositions according to the invention by the melt transesterification process is described, for example, in DE-A 4 238 123.

The incorporation of the UV absorbers into the compositions according to the invention takes place by conventional methods, e.g. by mixing solutions of the UV absorbers with solutions of the plastics in suitable organic solvents, such as CH₂Cl₂, haloalkanes, halogenated aromatics, chlorobenzene and xylenes. The substance mixtures are then homogenised by known means, preferably by extrusion. The solution mixtures are removed by known means by evaporating the solvent followed by extrusion, e.g. in extruders.

The compositions according to the invention can additionally contain suitable mould release agents.

Suitable mould release agents are e.g. the esters of long-chain aliphatic acids and alcohols. Esters of fatty acid alcohols or polyols, such as e.g. pentaerythritol with fatty acids, as described in DE-A 33 12 158, EP-A 0 100 918, EP-A 0 103 107, EP-A 0 561 629, EP-A 0 352 458, EP-A 0 436 117, or esters of fatty acids with Guerbet alcohols, which are described e.g. in U.S. Pat. No. 5,001,180, DE-A 33 12 157, U.S. Pat. No. 5,744,626, can be mentioned here as examples.

The compositions according to the invention can additionally contain stabilisers.

Suitable stabilisers are, for example, phosphines, phosphites or epoxides or Si-containing stabilisers and other compounds described in EP-A 0 500 496 and U.S. Pat. No. 3,673,146. Triphenyl phosphites, diphenylalkyl phosphites, phenyldialkyl phosphites, tris(nonylphenyl) phosphite, tetrakis(2,4-di-tert-butylphenyl)-4,4′-biphenylene diphosphonite and triaryl phosphite can be mentioned as examples. Triphenyl-phosphine and tris(2,4-di-tert-butylphenyl) phosphite are particularly preferred.

Furthermore, the compositions according to the invention and the products made therefrom can contain organic dyes, inorganic pigments, fluorescent dyes and particularly preferably optical brighteners.

The compositions according to the invention can be used for the extrusion of sheets. These sheets can be provided on one or both sides with co-extrusion layers.

Co-extrusion per se is known from the literature (cf. e.g. EP-A 0 110 221 and EP-A 0 110238).

Suitable UV absorbers for the co-extrusion moulding compositions that can optionally be used are preferably those compounds capable of effectively protecting polycarbonate from UV light owing to their absorption capacity below 400 nm and having a molecular weight of preferably more than 370, preferably 500 and more.

Suitable UV absorbers are especially the compounds of formula (II) described in WO 99/05205

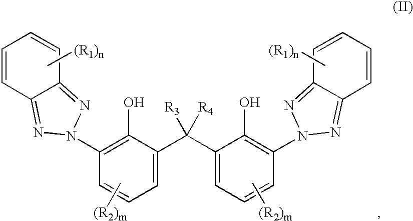

wherein

R¹ and R² are the same or different and signify H, halogen, C₁-C₁₀ alky, C₅-C₁₀ cycloalkyl, C₇-C₁₃ aralkyl, C₆-C₁₄ aryl, —OR⁵ or —(CO)—O—R⁵ with

R⁵=H or C₁-C₄ alkyl,

R³and R⁴ are also the same or different and signify H, C₁-C₄ alkyl, C₅-C₆ cycloalkyl, benzyl or C₆-C₁₄ aryl,

m is 1, 2 or 3 and

n is 1, 2, 3 or 4,

and those of formula (III)

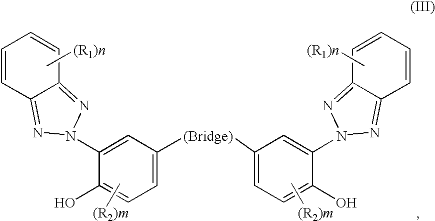

wherein the bridge signifies

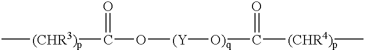

and

R¹, R², m and n have the meaning given for formula (II), and wherein

p is an integer from 0 to 3,

q is an integer from 1 to 10,

Y is —CH₂—CH₂—, —(CH₂)₃—, —(CH₂)₄—, —(CH₂)₅—, —(CH₂)₆— or CH(CH₃)—CH₂— and

R³ and R⁴ have the meaning given for formula (II).

Other suitable V absorbers are those which represent substituted triazines, such as 2,4-bis(2,4-dimethylphenyl)-6-(2-hydroxy-4-n-octyloxyphenyl)-1,3,5-triazine (CYASORB® UV-1 164) or 2-(4,6-diphenyl-1,3,5-triazin-2-yl)-5-(hexyl)oxyphenol (Tinuvin® 1577). Particularly preferred as a UV absorber is 2,2-methylenebis( 4-(1,1,3,3-tetramethylbutyl)-6-(2H-benzotriazol-2-yl)phenol, which is marketed commercially as Tinuvin® 360 or Adeka Stab® LA 31. The UV absorbers mentioned in EP-A 0 500 496 are also suitable. The UV absorber Uvinul® 3030 from BASF AG obtained in WO 96/15102, example 1, (formula (I) with R₁ to R₄₀=H) can also be used.

The compositions according to the invention can additionally contain antistatic agents.

Examples of antistatic agents are cationic compounds, e.g. quaternary ammonium, phosphonium or sulfonium salts, anionic compounds, e.g. alkyl sulfonates, alkyl sulfates, alkyl phosphates, carboxylates in the form of alkali or alkaline-earth metal salts, non-ionogenic compounds, e.g. polyethylene glycol esters, polyethylene glycol ethers, fatty acid esters, ethoxylated fatty amines. Preferred antistatic agents are non-ionogenic compounds.

All feedstock and solvents used for the synthesis of the compositions according to the invention can be contaminated with corresponding impurities from their production and storage, the aim being to work with the cleanest starting substances possible.

The mixing of the individual components can take place by known means, both successively and simultaneously and both at ambient temperature and at elevated temperature.

The incorporation of the additives into the compositions according to the invention preferably takes place by known means by mixing polymer granules with the additives and then extruding, or by mixing the solutions of polycarbonate with solutions of the additives and then evaporating the solvents by known means.

The proportion of additives can be varied within broad limits and depends on the desired properties of the compositions.

The total proportion of additives in the composition is preferably 0.01 to 20 wt. %, preferably 0.05 to 5 wt. %, particularly preferably 0.1 to 1.5 wt. %, based on the weight of the composition.

The compositions thus obtained can be converted to shaped objects (products), such as e.g. parts for toys, but also fibres, films, film tapes, solid sheets, multi wall sheets, corrugated sheets, vessels, pipes and other profiles, by the conventional methods, such as e.g. hot press moulding, spinning, extruding or injection moulding. The compositions can also be processed into cast films.

The invention thus also relates to the use of the compositions according to the invention for the production of a shaped object (products). The use of multi-layer systems is also of interest.

The invention also provides products that have been made incorporating the compositions according to the invention. The compositions according to the invention can be used for the production of solid plastic sheets and multi wall sheets (e.g. twin wall sheets, triple wall sheets etc.). The sheets also include those having an additional outer layer with an increased content of UV absorbers on one side or on both sides.

The compositions according to the invention enable products to be made with improved optical properties, especially sheets and products made from them, such as e.g. glazing (solid sheets, multi wall sheets and corrugated sheets) and structural parts in the building sector and in the automotive sector, and also plastic headlight lenses and spectacle lenses and lamp housings, lamp covers, housings for the electronics industry, bottles and films.

Subsequent treatments of the products made with the compositions according to the invention, such as e.g. thermoforming or surface treatments, e.g. coating with scratch resistant paints, water-spreading coatings, vapour deposition, sputtering, laminating with films or sheets and similar, are possible and the products made by these processes are also provided by the patent.

The invention is further illustrated by the following examples, without being limited to these.

### EXAMPLES

To prepare the test pieces for tests A to H, a polycarbonate with the trade name Makrolon® 3108 (linear bisphenol A polycarbonate from Bayer AG, Leverkusen, Germany, with a melt flow index (MFR) of 6.5 g/10 min at 300° C. and 1.2 kg load) was compounded with the specified quantity of UV absorber at 310° C. on a twin screw extruder and then granulated. Rectangular sheets (60 mm×40 mm×3 mm) were then made from these granules by injection moulding.

The weathering of these sheets took place in a Weather-o-meter from Atlas, USA, with a 6.5 W xenon burner in a cycle of 102 min illumination and 18 min spraying with demineralised water with illumination. The maximum black panel temperature was 60° C. (±5° C.).

The light transmission, the yellowness index and the haze were determined in accordance with ASTM specification D 1003 using Haze-Gard plus apparatus from BYK-Gardner GmbH, D-82538 Geretsried.

Table 1 gives a compilation of the results.

TABLE 1

| No. | UV absorber | Haze | Transmission |
|---|---|---|---|
| A | 0.3% Tinuvin ® 350 | 3.7 | 84.0% |
| B | 0.2% Tinuvin ® 350 | 1.9 | 85.4% |
| C | 0.1% Tinuvin ® 350 | 1.3 | 85.9% |
| D | 0.8% Uvinul ® 3030 | 4.2 | 83.7% |
| E | 0.3% Uvinul ® 3030 | 1.4 | 85.8% |
| F | 0.2% Uvinul ® 3030 | 1.2 | 86.0% |
| G | 0.1% Uvinul ® 3030 | 0.9 | 86.2% |
| H | 0.02% Uvinul ® 3030 | 0.5 | 86.5% |

Tinuvin ® 350 = 2-(2H-benzotriazol-2-yl)-4-(1,1-dimethylethyl)-6-(2-methyl-propyl)phenol
Uvinul ® 3030 = formula (I) with R₁ to R₄₀ equal to H.

The result shows that the injection moulded sheets incorporating Uvinul® 3030 have lower haze values and better light transmission values than the injection moulded sheets incorporating Tinuvin® 350. This is true at least in a range of concentration of 0.1 to 0.3 wt. %.

At concentrations of Uvinul® 3030 that are too high (0.8%), the haze becomes too great. Polycarbonate sheets with such high haze are no longer usable.

TABLE 2
Development of the yellowness index and haze with artificial
weathering (Xe-WOM), (cycles: 102 min irradiation; 18 min
irradiation + water spray)

| | Yellowness index | | |
|---|---|---|---|
| No. | 0 h | 5000 h | 8000 h |
| B | 4.9 | 17.3 | 22.4 |
| F | 4.9 | 16.4 | 21.5 |
| H | 4.1 | 21.4 | 29.3 |

The result shows that B and F are very similar in their weathering behaviour. H is striking for its excessively marked yellowing. These polycarbonate sheets are not suitable for glazing. The concentration of 0.02 wt. % Uvinul® 3030 is too low for adequate UV stabilising.

1) Composition containing
a) a transparent thermoplastic polymer and
b) one or more different compounds according to formula (I) 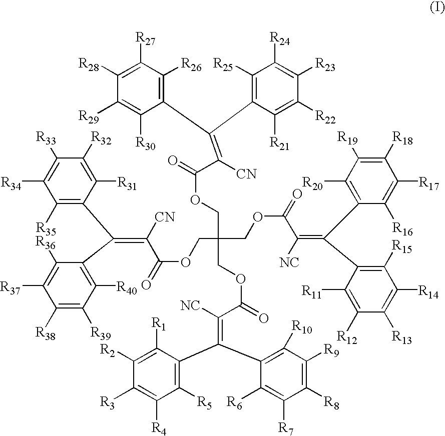
wherein
R₁ to R₄₀ are the same or different and are selected from the group consisting of H, alkyl, halogen and —CN.

2. Composition according to claim 1, wherein R₁ to R₄₀ are equal to H.

3. Composition according to claims 1 or 2, which contain 0.08 to 0.6 wt. % of the compounds according to formula (I).

4. Composition according to any one of claims 1 to 3, wherein the transparent thermoplastic polymer is selected from the group consisting of polycarbonate, polymethyl methacrylate, polyethyl methacrylate, polystyrene, polysulfone, styrene-acrylonitrile copolymer, polyester, polyethylene terephthalate, polybutylene terephthalate, copolyesters of polyethylene terephthalate with cyclohexanedimethanol, copolyesters of polybutylene terephthalate with cyclohexanedimethanol, polyether sulfone, polyethylene, polypropylene and mixtures of the above polymers.

5. Composition according to any one of claims 1 to 3, wherein the transparent thermoplastic polymer is polycarbonate.

6. Composition according to any one of claims 1 to 5, which additionally contains 0.01 to 1 wt. % pentaerythritol tetrastearate or glycerol monostearate or fatty acid esters of Guerbet alcohols or mixtures thereof.

7. Product containing the composition according to any one of claims 1 to 6.

8. Product according to claim 7, wherein the product is selected from the group consisting of sheets, solid sheets, multi wall sheets, corrugated sheets, glazing panels, greenhouses, conservatories, bus shelters, advertising panels, signs, safety screens, automobile glazing, windows, roofing, plastic headlight lenses and spectacle lenses.

9. Product according to claim 7 or 8, wherein the product is multi-layer and wherein at least one layer contains a sufficiently high content of a UV absorber that the layers below it are protected from the harmful effects of UV light.

10. Product according to claim 9, wherein the layer with the increased proportion of UV absorber is applied by co-extrusion.

11. Product according to claim 9, wherein the layer with the increased proportion of UV absorber is applied by painting.
